(19) United States
(12) Patent Application Publication
(10) Pub. No.: US 2019/0179239 A1
(43) Pub. Date: Jun. 13, 2019

(54) IMAGE FORMING APPARATUS

(71) Applicant: CANON KABUSHIKI KAISHA, Tokyo (JP)

(72) Inventor: Yusuke Minato, Toride-shi (JP)

(21) Appl. No.: 16/278,892

(22) Filed: Feb. 19, 2019

Related U.S. Application Data
(63) Continuation of application No. PCT/JP2017/025287, filed on Jul. 11, 2017.

(30) Foreign Application Priority Data
Aug. 30, 2016 (JP) 2016-168561
Jun. 23, 2017 (JP) 2017-123736

(51) Int. Cl. G03G 15/16

(52) U.S. Cl. CPC G03G 15/161; G03G 15/1665

(57) ABSTRACT

An image forming apparatus includes an image bearing member, a transfer roller, a power feeding roller, a power source, and a controller. The controller is configured to execute a cleaning mode of cleaning the power feeding roller by applying a bias from the power source to the power feeding roller to transfer toner adhering on the power feeding roller to the image bearing member in a non-image formation period. The controller executes the cleaning mode in such a manner that, when a rotation time in which the transfer roller rotates one round is t1 and a rotation time in which the power feeding roller rotates one round is t2, the cleaning mode comprises a period equal to or longer than (t1+t2) in which an opposite polarity bias having an opposite polarity to the transfer bias is continuously applied from the power source to the power feeding roller.

### CROSS-REFERENCE TO RELATED APPLICATIONS

This application is a Continuation of International Patent Application No. PCT/JP2017/025287, filed Jul. 11, 2017, which claims the benefit of Japanese Patent Application No. 2016-168561, filed Aug. 30, 2016, and No. 2017-123736, filed Jun. 23, 2017, those of which are hereby incorporated by reference herein in their entirety.

### BACKGROUND OF THE INVENTION

### Field of the Invention

The present invention relates to an image forming apparatus such as a copier, a printer, a facsimile machine, or a multifunctional apparatus having a plurality of functions of these.

### Background Art

Conventionally, an image forming apparatus of an intermediate transfer system that primary-transfers a toner image formed on a photosensitive drum onto an intermediate transfer belt serving as an image bearing member and secondary-transfers the toner image on the intermediate transfer belt onto a recording medium is known. A transfer roller (secondary transfer outer roller) that abuts an outer circumferential surface of the intermediate transfer belt is disposed in a secondary transfer portion in which the toner image is secondary-transferred onto the recording material, and the secondary transfer is performed by applying a transfer voltage to the transfer roller.

In the transfer roller, an elastic layer is provided on a peripheral surface of a conductive shaft portion, and conductivity is imparted to the elastic layer by dispersing a conducting agent such as an ionic conducting agent therein. Therefore, in the case where an application time of the voltage to the transfer roller becomes long due to use, ions in the ionic conducting agent are polarized so as to be unevenly present on one of the roller surface side or the shaft portion side, and thus the resistance is likely to increase. Therefore, an image forming apparatus that transfers a toner image from an intermediate transfer belt onto a recording material by applying a voltage from a power supply roller serving as a power feeding roller abutting the surface of a transfer roller to the transfer roller to suppress the increase in the resistance caused by the polarization is proposed (Japanese Patent Laid-Open No. 2005-316200).

However, in the transfer roller disclosed in Japanese Patent Laid-Open No. 2005-316200, in the case where the toner from the intermediate transfer belt is attached to the transfer roller, the toner sometimes also attaches to the power supply roller abutting the transfer roller. When toner attachment to the power supply roller occurs, there is a possibility that unevenness occurs in a current flowing from the power supply roller to the transfer roller. In addition, there is a case where the toner attached to the power supply roller reattaches to the transfer roller and stains the back surface of the recording material.

To suppress the toner attachment to the power supply roller to solve this, a configuration in which the power supply roller is provided with a cleaning member and a configuration in which the power supply roller is electrostatically cleaned by applying a voltage of the same polarity as the toner to the power supply roller can be considered. Since a toner collecting portion needs to be provided and the size of the image forming apparatus increases in the configuration of providing the power supply roller with a cleaning member, the configuration of electrostatically performing cleaning is desirable. In the configuration of electrostatically performing cleaning, since the toner moves from the power supply roller to the transfer roller, the transfer roller also needs to be cleaned to suppress reattachment of toner to the recording material.

Therefore, an object of the present invention is to provide, regarding an image forming apparatus including a power feeding roller, an image forming apparatus capable of suppressing reattachment of toner to a recording material without additionally providing a cleaning member to a power feeding roller.

### SUMMARY OF THE INVENTION

According to one aspect of the present invention, an image forming apparatus includes an image bearing member configured to bear a toner image, a transfer roller comprising a conductive shaft portion and an elastic layer formed around the conductive shaft portion, the transfer roller forming a transfer portion where the transfer roller is in contact with an outer surface of the image bearing member to transfer the toner image borne on the image bearing member onto a recording medium, a power feeding roller configured to rotate while in contact with the transfer roller to supply a current to the transfer roller to transfer the toner image at the transfer portion, a power source configured to apply a transfer bias to the power feeding roller, and a controller configured to execute a cleaning mode of cleaning the power feeding roller by applying a bias from the power source to the power feeding roller to transfer toner adhering on the power feeding roller to the image bearing member through the transfer roller in a non-image formation period in which a toner image for being transferred onto a recording material is not formed. The controller is configured to execute the cleaning mode in such a manner that, in a case where a rotation time in which the transfer roller rotates one round is t1 and a rotation time in which the power feeding roller rotates one round is t2, the cleaning mode comprises a period equal to or longer than (t1+t2) in which an opposite polarity bias having an opposite polarity to the transfer bias is continuously applied from the power source to the power feeding roller.

Further features of the present invention will become apparent from the following description of exemplary embodiments with reference to the attached drawings.

### BRIEF DESCRIPTION OF THE DRAWINGS

FIG. 1 is a section view illustrating a schematic configuration of an image forming apparatus according to a first embodiment.

FIG. 2 is a schematic control block diagram of the image forming apparatus according to the first embodiment.

FIG. 3 is a flowchart illustrating a procedure of executing secondary transfer voltage control in the image forming apparatus according to the first embodiment.

FIG. 4A is a schematic diagram illustrating a state in which a secondary transfer outer roller and a power supply roller are contaminated by toner in a procedure of executing a cleaning mode of a secondary transfer portion in the image forming apparatus of the first embodiment.

FIG. 4B is a schematic diagram illustrating a state in which the secondary transfer outer roller has rotated by a half rotation in the procedure of executing the cleaning mode of the secondary transfer portion in the image forming apparatus of the first embodiment.

FIG. 4C is a schematic diagram illustrating a state in which the secondary transfer outer roller has rotated once in the procedure of executing the cleaning mode of the secondary transfer portion in the image forming apparatus of the first embodiment.

FIG. 4D is a schematic diagram illustrating a state in which the secondary transfer outer roller has rotated once and then the power supply roller has rotated once in the procedure of executing the cleaning mode of the secondary transfer portion in the image forming apparatus of the first embodiment.

FIG. 5A is a graph illustrating temporal change in a cleaning bias applied to the power supply roller according to the first embodiment, and corresponds to a case where cleaning biases of negative polarity and positive polarity are each applied once for a total time of a time corresponding to one rotation of the secondary transfer outer roller and a time corresponding to one rotation of the power supply roller.

FIG. 5B is a graph illustrating temporal change in the cleaning bias applied to the power supply roller according to the first embodiment, and corresponds to a case where cleaning biases of negative polarity and positive polarity are each applied once for the time corresponding to one rotation of the secondary transfer outer roller.

FIG. 6 is a flowchart illustrating a processing procedure of a cleaning mode of the secondary transfer portion in the image forming apparatus according to the first embodiment.

FIG. 7 is a flowchart illustrating a processing procedure of a cleaning mode of the secondary transfer portion in an image forming apparatus according to a second embodiment.

FIG. 8A is a graph illustrating temporal change in a cleaning bias applied to the power supply roller according to the first embodiment, and corresponds to a case where a cleaning bias of a negative polarity is applied for a total time of a time corresponding to one rotation of the secondary transfer outer roller and a time corresponding to one rotation of the power supply roller, and a cleaning bias of a positive polarity is applied for a time corresponding to one rotation of the secondary transfer outer roller.

FIG. 8B is a graph illustrating temporal change in a cleaning bias applied to the power supply roller according to the first embodiment, and corresponds to a case where cleaning biases of negative polarity and positive polarity are each alternately applied twice each for a total time of a time corresponding to one rotation of the secondary transfer outer roller and a time corresponding to one rotation of the power supply roller.

FIG. 8C is a graph illustrating temporal change in a cleaning bias applied to the power supply roller according to the first embodiment, and corresponds to a case where a cleaning bias of a negative polarity is applied for a total time of a time corresponding to one rotation of the secondary transfer outer roller and a time corresponding to one rotation of the power supply roller, and a cleaning bias of a positive polarity, a cleaning bias of a negative polarity, and a cleaning bias of a positive polarity are sequentially applied each for a time corresponding to one rotation of the secondary transfer outer roller.

### DESCRIPTION OF THE EMBODIMENTS

### First Embodiment

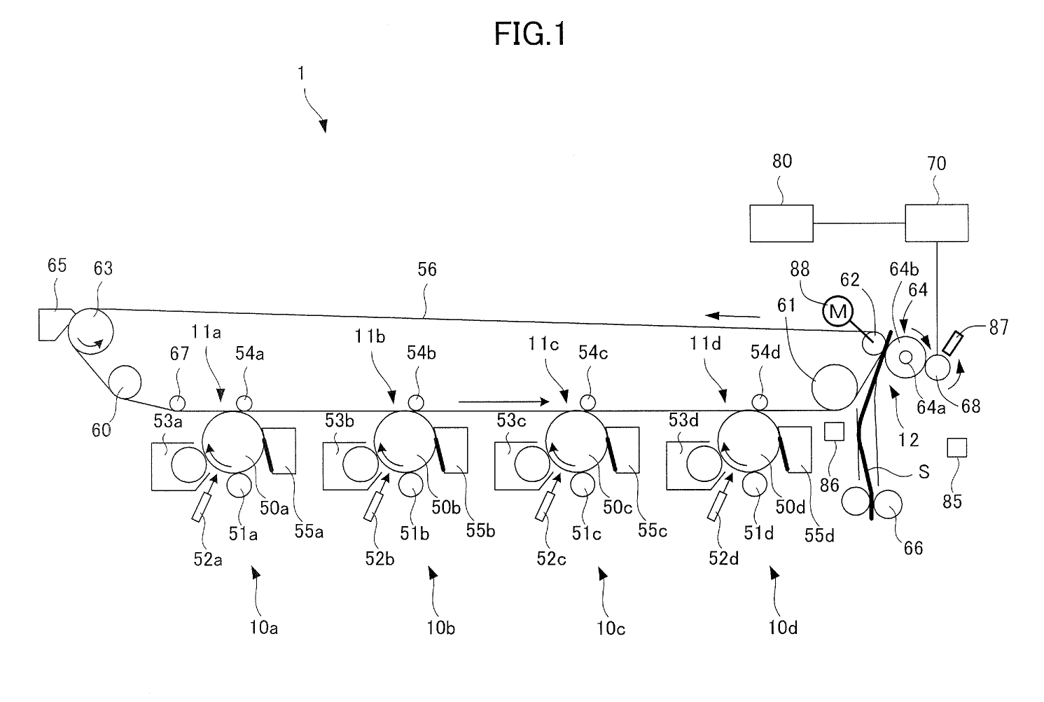

A first embodiment will be described with reference to FIGS. 1 to 6 and FIGS. 8A to 8C. First, a schematic configuration of an image forming apparatus of the present embodiment will be described with reference to FIG. 1.

### Image Forming Apparatus

In the present embodiment, an image forming apparatus 1 is a full-color printer of a so-called tandem type intermediate transfer system in which a plurality of image forming portions 10a, 10b, 10c, and 10d are arranged along a rotation direction (movement direction) of an intermediate transfer belt 56. Such an image forming apparatus 1 forms a full-color image on a sheet S serving as an example of a recording material by an electrophotographic system in accordance with an image signal transmitted from an external device such as a personal computer, an image signal from a document reading apparatus, or the like. To be noted, a toner image is to be formed on the sheet S, and specific examples of the sheet S include regular paper, sheets of synthetic resins serving as substitutes for regular paper, cardboards, and sheets for overhead projectors.

The image forming apparatus 1 includes an unillustrated apparatus body accommodating the image forming portions 10a, 10b, 10c, and 10d. The image forming portions 10a to 10d respectively include photosensitive drums 50a, 50b, 50c, and 50d that each rotate in an arrow direction of FIG. 1. Surfaces of the photosensitive drums 50a to 50d are respectively charged by charging rollers 51a, 51b, 51c, and 51d. Electrostatic latent images are formed on the charged photosensitive drums 50a to 50d by exposing apparatuses 52a, 52b, 52c, and 52d. The electrostatic latent images on the photosensitive drums 50a to 50d are visualized as toner image by developing apparatuses 53a, 53b, 53c, and 53d accommodating toners of respective color components. In the case of the present embodiment, the developing apparatuses 53a to 53d each use a two-component developer containing nonmagnetic toner and magnetic carrier, and the charging polarity of the toner is a negative polarity. To be noted, the developing apparatuses 53a to 53d may be configured to use a one-component developer.

Primary transfer rollers 54a, 54b, 54c, and 54d are disposed at positions opposing the photosensitive drums 50a to 50d with an intermediate transfer belt 56 therebetween, and respectively form primary transfer portions T1a, T1b, T1c, and T1d. Toner images of respective colors formed on the photosensitive drums 50a to 50d are sequentially primary-transferred onto the intermediate transfer belt 56 so as to be superimposed on one another by applying a primary transfer bias to the primary transfer rollers 54a to 54d. Toner remaining on the photosensitive drums 50a to 50d after the primary transfer is removed by drum cleaning apparatuses 55a, 55b, 55c, and 55d. These image forming portions 10a, 10b, 10c, and 10d are arranged in the order of yellow (Y), magenta (M), cyan (C), and black (K) from the upstream side of the intermediate transfer belt 56.

Meanwhile, a sheet S accommodated in a recording material accommodating cassette (not illustrated) is conveyed from a registration roller 66 to a secondary transfer portion (transfer portion) T2 to match a formation timing of a toner image. Then, the toner images primary-transferred in a superimposed manner onto the intermediate transfer belt 56 are collectively transferred (secondary-transferred) in the secondary transfer portion T2 by applying a secondary transfer bias to the secondary transfer portion T2. The detailed configuration of the secondary transfer portion T2 will be described later. Toner remaining on the intermediate transfer belt 56 without being completely transferred in the secondary transfer portion T2 and paper dust are removed by a belt cleaning apparatus 65.

The belt cleaning apparatus 65 is disposed to oppose a tension roller 63 with the intermediate transfer belt 56 therebetween at a position downstream of the secondary transfer portion T2 and upstream of all the primary transfer portions T1a to T1d in the rotation direction of the intermediate transfer belt 56. Then, the belt cleaning apparatus 65 cleans the surface of the intermediate transfer belt 56 by bringing a blade into contact with the intermediate transfer belt 56 at this position.

Next, the sheet S is conveyed to an unillustrated fixing apparatus. Then, the toner on the sheet S is melted and fixed by being heated and pressurized, and is thus fixed onto the sheet S as a full-color image. Then, the sheet S is discharged to the outside of the apparatus body. As a result of this, the series of image formation processes is finished. In this manner, the operation of each apparatus is controlled by a controller 80.

### Intermediate Transfer Belt

The intermediate transfer belt 56 serving as an image bearing member is an endless belt of a film shape, and conveys the toner images primary-transferred from the respective photosensitive drums 50a to 50d as described above by rotating (moving) while carrying the toner images. For such an intermediate transfer belt 56, a material obtained by adding an appropriate amount of antistatic agent such as carbon black to a resin such as polyimide or polyamide, an alloy thereof, or various rubbers is used. Further, the intermediate transfer belt 56 is formed such that the surface resistivity thereof is 1×10⁹ to 5×10¹³Ω/□, and the thickness thereof is, for example, about 0.04 to 0.50 mm.

The intermediate transfer belt 56 is stretched over idler rollers 60, 61, and 67, a tension roller 63, and a secondary transfer inner roller 62. The tension roller 63 imparts a tensile force of, for example, about 3 to 12 kgf (about 29 to 118 N) to the intermediate transfer belt 56. The secondary transfer inner roller 62 is rotationally driven by a driving motor (driving means) 88, and rotates the intermediate transfer belt 56 at a predetermined speed.

### Primary Transfer Rollers

The primary transfer rollers 54a to 54d are provided inside of the intermediate transfer belt 56, and are formed from metal rollers whose material is SUM (sulfur and sulfur-composite free-cutting steel), SUS (stainless steel) or the like. A voltage (primary transfer bias) of an opposite polarity to the charging polarity of the toner is applied to the primary transfer rollers 54a to 54d. As a result of this, a primary transfer contrast that is a potential difference between the surface potential of the photosensitive drums 50a to 50d and the potential of the primary transfer rollers 54a to 54d is formed. As a result of predetermined primary transfer contrasts being respectively formed in the primary transfer portions T1a to T1d, the respective toner images on the photosensitive drums 50a to 50d are sequentially electrostatically attracted to the intermediate transfer belt 56, and thus toner images superimposed on the intermediate transfer belt 56 are formed. To be noted, the primary transfer rollers 54a to 54d have straight shapes in a thrust direction, and the roller diameters thereof are about 6 to 10 mm.

### Secondary Transfer Portion

The secondary transfer portion T2 is formed by the secondary transfer outer roller 64 serving as a transfer roller abutting a toner image bearing surface (outer surface) of the intermediate transfer belt 56. That is, the secondary transfer outer roller 64 forms, together with the intermediate transfer belt 56, the secondary transfer portion T2 in which the toner images carried by the intermediate transfer belt 56 are transferred onto the sheet S. Specifically, the secondary transfer inner roller 62 is disposed such that the intermediate transfer belt 56 is nipped between the secondary transfer inner roller 62 and the secondary transfer outer roller 64, and thus forms a nip portion in which a recording material is nipped between the intermediate transfer belt 56 and the secondary transfer outer roller 64. Further, the toner images carried by the intermediate transfer belt 56 are transferred onto the sheet S, the recording material passing through this nip portion.

In addition, the secondary transfer outer roller 64 transfers the toner images from the intermediate transfer belt 56 onto the recording material by being provided with a current from a power supply roller 68 serving as a power feeding roller. That is, the power supply roller 68 abuts the secondary transfer outer roller 64 at a position different from the secondary transfer portion T2 in the circumferential direction of the power supply roller 68 and rotates, and thus is capable of supplying a current to the secondary transfer outer roller 64 to transfer the toner images in the secondary transfer portion T2. The power supply roller 68 is connected to a high-voltage power source (power source) 70, and is capable of applying a voltage (transfer bias) to the power supply roller 68. The high-voltage power source 70 supplies an electric field used for secondary transfer and various control to the secondary transfer portion T2. In the present embodiment, a constant voltage power source is used as the high-voltage power source 70.

Here, the secondary transfer inner roller 62 is constituted by providing EPDM (ethylene-propylene diene rubber) around a core metal. The secondary transfer inner roller 62 is formed to have a roller diameter of 20 mm and a rubber thickness of 0.5 mm, and the hardness thereof is set to, for example, 70° (Asker C).

Meanwhile, the secondary transfer outer roller 64 includes a core metal 64a serving as a shaft portion having conductivity, and an elastic layer 64b serving as an outer circumferential surface containing a conducting agent formed on the outer circumference of the core metal 64a. That is, the secondary transfer outer roller 64 is constituted by providing the elastic layer 64b formed from NBR (nitrile rubber) or EPDM containing a conducting agent such as a metal complex or carbon around the core metal 64a. The secondary transfer outer roller 64 is formed such that the roller diameter is 24 mm and the thickness of the elastic layer (sponge layer) 64b is 6 mm.

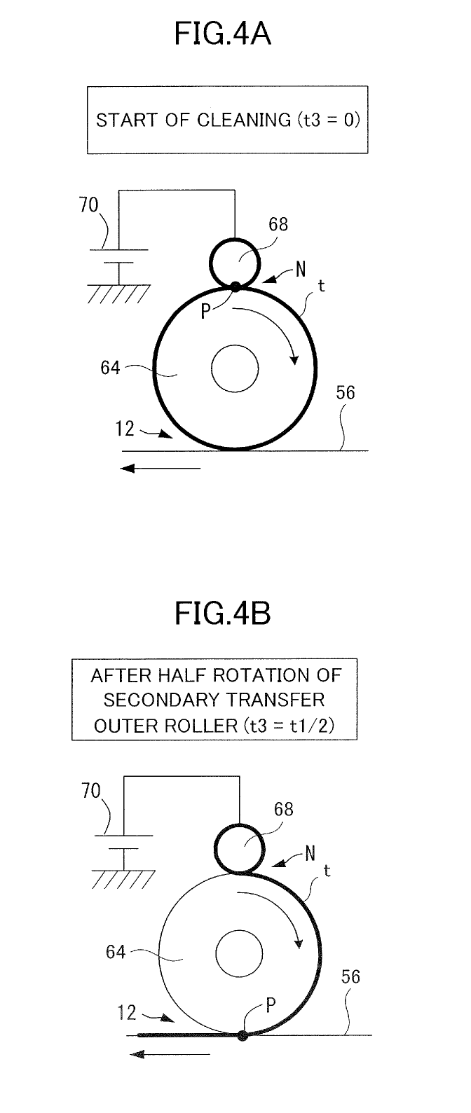

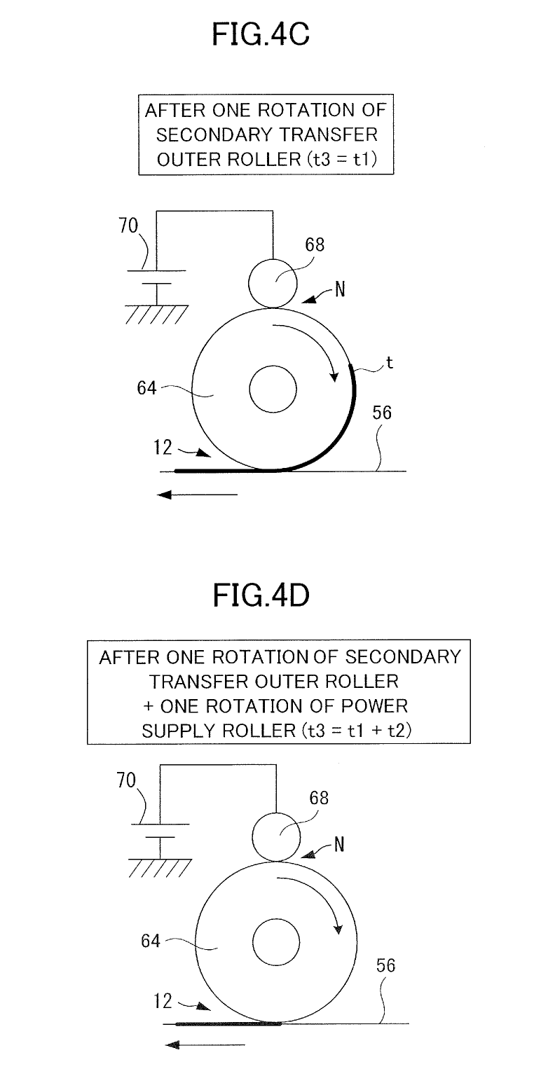

The power supply roller 68 is positioned so as to abut the secondary transfer inner roller 62 at a power supply nip portion N (see FIG. 4A) on the side opposite to the secondary transfer outer roller 64. Specifically, the power supply roller 68 is disposed such that the power supply nip portion N in which the power supply roller 68 abuts the secondary transfer outer roller 64 is at a position displaced from the abutting position between the secondary transfer outer roller 64 and the intermediate transfer belt 56 by approximately 180° in the rotation direction of the secondary transfer outer roller 64. To be noted, the position of the power supply nip portion N may be a different position as long as the position is different from the abutting position between the secondary transfer outer roller 64 and the intermediate transfer belt 56.

In addition, the power supply roller 68 abuts the secondary transfer outer roller 64 by being pressurized at both ends thereof in the rotation axis direction toward the secondary transfer outer roller 64 by unillustrated springs. The power supply roller 68 has a configuration in which a metal roller whose material is SUM, SUS, or the like is coated with a conductive resin containing a conductive substance. The diameter of the metal roller is about 4 to 15 mm, and the thickness of the conductive resin is 1 to 200 μm. In the case where the diameter of the metal roller is smaller than this, there is a possibility that warpage occurs at the time of pressurization, thus resistance unevenness occurs in the secondary transfer outer roller 64 as a result of being not capable of uniformly applying a voltage in the longitudinal direction (rotation axis direction) or cracking and peeling of the conductive resin occurs. In contrast, in the case where the diameter of the metal roller is larger than this, the costs for the material increase, and the size and weight of the power supply roller 68 increase. Therefore, it is preferable that the diameter of the metal roller is within the range described above.

Examples of the conductive substance contained in the conductive resin include carbon black and carbon fiber. As a method of forming the conductive resin, first, the conductive substance described above is dissolved and dispersed in an appropriate organic solvent to obtain a coating liquid for a surface layer. Next, this coating liquid for a surface layer is applied on the outer circumference of the metal roller by a method such as ring coating, dip coating, or spray coating, and drying is performed to remove the organic solvent. To be noted, it is desirable that this drying treatment is performed in an environment of about 30 to 60° C. so as not to cause radical reaction. Then, curing by ultraviolet light is performed by using an ultraviolet light irradiator to obtain the power supply roller 68 described above. In the present embodiment, a metal roller of SUS having a diameter of 8 mm is coated with a conductive resin of 10 μm by dip coating. As the conductive resin, a resin obtained by adding perfluoropolyether and zinc antimonate to an acrylic resin is used. In addition, the spring pressure of the power supply roller 68 is set to a total pressure of 500 gf (approximately 4.9 N). As a result of this, the warpage of the power supply roller 68 is prevented, and increase in the cost of components and increase in the size of the secondary transfer portion T2 are suppressed. To be noted, although a case where coating is formed on a surface layer of the power supply roller 68 has been described in the present embodiment, this is not limiting, and a metal roller of SUM or SUS may be used as it is, or the surface thereof may be plated.

At the time of image formation operation, the secondary transfer outer roller 64 rotates to follow running of the intermediate transfer belt 56. Further, the power supply roller 68 follows the rotational driving of the secondary transfer outer roller 64. When the sheet S is conveyed to the secondary transfer portion T2 by the registration roller 66 after various control is performed, a secondary transfer bias of an opposite polarity to the charging polarity of the toner is applied to the power supply roller 68 to secondary-transfer the toner images formed on the intermediate transfer belt 56 onto the sheet S. In the present embodiment, a bias of a positive polarity is applied as the secondary transfer bias on the premise that the toner has a negative charging polarity.

To be noted, an environment detection sensor 85 that detects an environment such as the temperature and humidity inside the apparatus body and a density detection sensor 86 are provided inside the apparatus body. The density detection sensor 86 is disposed to oppose the surface of the intermediate transfer belt 56 downstream of all the primary transfer portions T1a to T1d and upstream of the secondary transfer portion T2, and is capable of detecting the toner images on the intermediate transfer belt 56.

### Controller

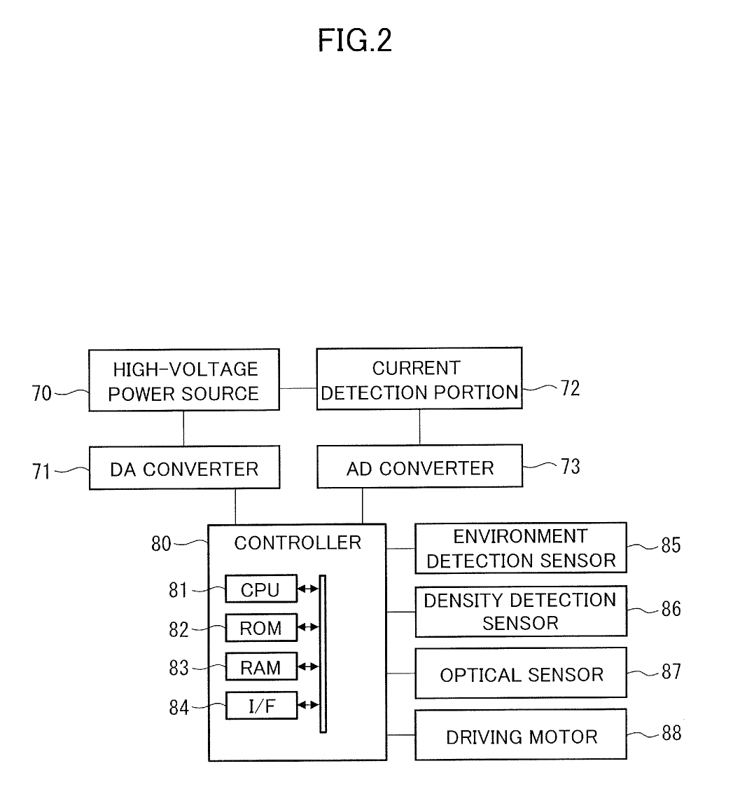

As illustrated in FIG. 2, the controller 80 is constituted by a computer and includes, for example, a CPU 81, a ROM 82 that stores a program for controlling each component, a RAM 83 that temporarily stores data, and an input/output circuit (I/F) 84 that inputs and outputs signals from and to the outside. The CPU 81 is a microprocessor that performs overall control of the image forming apparatus 1, and is a main body of a system controller. The CPU 81 is connected to each component of the image forming apparatus 1 via the input/output circuit 84, communicates signals with each component, and controls operations. The ROM 82 stores an image formation control sequence for forming an image on the sheet S, a high-voltage output table that is a relationship between the temperature and humidity and the voltage applied to the power supply roller 68, and so forth. To be noted, the CPU 81 controls the high-voltage power source 70 with reference to the high-voltage output table to apply the secondary transfer bias and a cleaning bias that will be described later to the power supply roller 68.

In addition, the controller 80 is connected to a DA converter 71, an AD converter 73, the environment detection sensor 85, the density detection sensor 86, an optical sensor 87, the driving motor 88, and so forth. The DA converter 71 is connected to the high-voltage power source 70, converts a command of a digital signal from the controller 80 to an analog signal, and thus causes the high-voltage power source 70 to output a high voltage. The high-voltage power source 70 is connected to a current detection portion 72, and a current at the time of the high-voltage output is detected by the current detection portion 72. The current detection portion 72 is connected to the AD converter 73, and a detection result of the current detection portion 72 is converted into a digital signal and input to the controller 80.

In the case where it is determined that the state of the toner accommodated in the developing apparatuses 53a to 53d have deteriorated due to use or environmental change, the controller 80 performs control to discharge the toner of the developing apparatuses 53a to 53d onto the intermediate transfer belt 56 and collect the toner by the belt cleaning apparatus 65. During a non-image formation period in which a toner image for being transferred onto a recording material is not formed, the controller 80 applies an opposite polarity bias having an opposite polarity to the secondary transfer bias from the high-voltage power source 70 to the power supply roller 68. Then, the controller 80 causes the secondary transfer outer roller 64 to abut the intermediate transfer belt 56 and rotates the secondary transfer outer roller 64, the power supply roller 68, and the intermediate transfer belt 56 in a state in which the secondary transfer outer roller 64 is in contact with the power supply roller 68 while applying the opposite polarity bias. As a result of this, the controller 80 is capable of executing a cleaning mode (hereinafter also referred to as cleaning control) of cleaning the power supply roller 68 by moving the toner attached to the power supply roller 68 to the intermediate transfer belt 56 via the secondary transfer outer roller 64. The controller 80 has a first cleaning mode including a period equal to or longer than (t1+t2) of continuously applying the opposite polarity bias to the power supply roller 68 in the case where a rotation time in which the secondary transfer outer roller 64 rotates one round is t1 and a rotation time in which the power supply roller 68 rotates one round is t2. In addition, the controller 80 is configured to execute the first cleaning mode before resuming image formation in the case where the cleaning control is executed after a jam of the sheet S has occurred. In addition, in the case where a predetermined toner image for control is formed on the intermediate transfer belt 56 in a non-image formation time, the controller 80 is configured to execute the first cleaning mode after the toner image for control has passed through the secondary transfer portion T2, when executing the cleaning control.

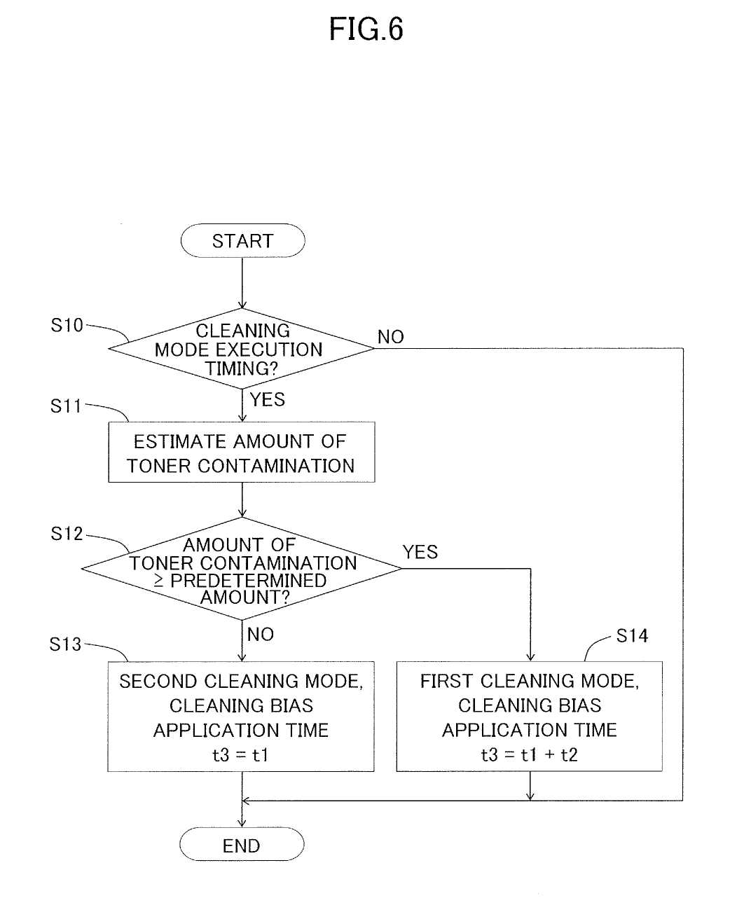

In addition, in the present embodiment, in the case where the first cleaning mode includes a plurality of first application periods T1, the first period is set to be the longest among the plurality of periods. In addition, the cleaning mode includes a second cleaning mode in which the period of continuously applying the opposite polarity bias to the power supply roller 68 is shorter than (t1+t2) at longest. In the present embodiment, the controller 80 executes the second cleaning mode when starting or finishing an image forming operation. In other words, in the controller 80 of the present embodiment, in the case where the period of continuously applying the opposite polarity bias is t3, the second cleaning mode is a mode in which t3 does not exceed t1+t2 at largest and a relationship of t1≤t3<t1+t2 is satisfied (step S13 of FIG. 6). In addition, the first cleaning mode is a mode at least including a period in which t3≥t1+t2 is satisfied (step S14 of FIG. 6).

In addition, in the present embodiment, the controller 80 may switch the cleaning mode in accordance with an image ratio in the case of executing the cleaning control after a jam of the sheet S has occurred and before resuming image formation. That is, the first cleaning mode may be executed in the case where the image ratio of an image carried by the intermediate transfer belt 56 at the time of occurrence of jam is equal to or larger than a predetermined ratio. In contrast, the controller 80 may be configured to execute the first cleaning mode or the second cleaning mode in the case where the image ratio of the image carried by the intermediate transfer belt 56 at the time of occurrence of jam is smaller than the predetermined ratio. In addition, the controller 80 may be configured to execute the second cleaning mode in the case of executing the cleaning control when starting or finishing the image forming operation.

In addition, in the present embodiment, the first cleaning mode is configured to include a period equal to or longer than (t1+t2) of continuously applying a same polarity bias having the same polarity as the transfer bias from the high-voltage power source 70 to the power supply roller 68. In addition, the second cleaning mode includes a period of continuously applying the same polarity bias having the same polarity as the transfer bias from the high-voltage power source 70 to the power supply roller 68, and the period of applying the same polarity bias is shorter than (t1+t2) at longest.

In the cleaning control, the controller 80 rotates the intermediate transfer belt 56, the secondary transfer outer roller 64, and the power supply roller 68 while applying the opposite polarity bias from the high-voltage power source 70. Then, the controller 80 enables cleaning the secondary transfer outer roller 64 and the power supply roller 68 by rotating the intermediate transfer belt 56, the secondary transfer outer roller 64, and the power supply roller 68 while applying the same polarity bias having the same polarity as the transfer bias from the high-voltage power source 70. In addition, the controller 80 is capable of executing, as the cleaning control, the second cleaning mode during a normal operation and the first cleaning mode during a predetermined operation. Here, during the predetermined operation is, for example, during an operation in which an amount of toner contamination is equal to or larger than a predetermined amount, and during the normal operation is during an operation in which the amount of toner contamination is smaller than the predetermined amount. In addition, in the present embodiment, the controller 80 is capable of applying the opposite polarity bias in the first cleaning mode such that a relationship of t3=t1+t2 is satisfied. That is, in the first cleaning mode, the period of continuously applying the opposite polarity bias to the power supply roller 68 is t1+t2. Further, in the present embodiment, the controller 80 is capable of applying the opposite polarity bias in the second cleaning mode such that a relationship of t3=t1 is satisfied. That is, in the second cleaning mode, the period of continuously applying the opposite polarity bias to the power supply roller 68 is t1.

To be noted, in the present embodiment, an image formation job is a series of operations as shown below performed on the basis of a print command signal (image formation command signal). That is, an image formation job is a series of operations from starting a preliminary operation (so-called pre-rotation) required for performing image formation and to completing a preliminary operation (so-called post-rotation) required for finishing image formation through an image forming step. Specifically, the image formation job refers to the pre-rotation (preparation operation before image formation) after receiving the print command signal (input of image formation job) to the post-rotation (operation after image formation), and includes an image formation period, and a sheet interval (non-image formation time). In addition, the sheet interval is a period corresponding to an interval between a toner image formed on one sheet and a toner image formed on the next one sheet in the case of successively performing image formation.

Next, the image forming operation in the image forming apparatus 1 thus configured will be described. After the image forming operation is started, first the photosensitive drums 50a to 50d rotate and the surfaces thereof are charged by the charging rollers 51a to 51d. Then, laser light is radiated onto the photosensitive drums 50a to 50d by the exposing apparatuses 52a to 52d on the basis of image information, and electrostatic latent images are formed on the surfaces of the photosensitive drums 50a to 50d. By developing these electrostatic latent images by the developing apparatuses 53a to 53d, these electrostatic latent images are visualized as toner images, and are transferred onto the intermediate transfer belt 56.

Meanwhile, the sheet S is supplied in parallel with such a formation operation of a toner image, and the sheet S is conveyed to the secondary transfer portion T2 via the conveyance path at a timing matching the toner images on the intermediate transfer belt 56. Further, the image is transferred onto the sheet S from the intermediate transfer belt 56, the sheet S is conveyed to the fixing apparatus, the unfixed toner image is heated and pressurized here and thus fixed onto the surface of the sheet S, and the sheet S is discharged from the apparatus body.

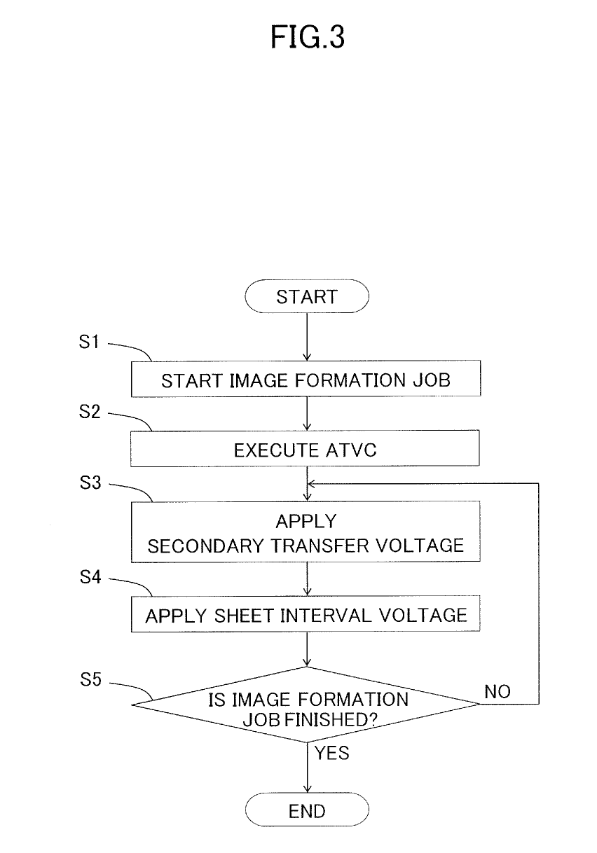

Next, secondary transfer voltage control in the image forming apparatus 1 of the present embodiment will be described in accordance with a flowchart illustrated in FIG. 3. When the image formation job is started (step S1), the controller 80 sets the secondary transfer voltage (ATVC) during the pre-rotation such that a desired secondary transfer current (for example, −40 μA in the present embodiment) flows (step S2). Specifically, the controller 80 calculates a V-I characteristic from current values respectively detected when two or more arbitrary different voltages are applied, and thus a voltage value that should be applied to obtain an aimed current value is obtained. Further, the controller 80 adds a sharing voltage corresponding to a sheet type such as regular paper or cardboard stored in the ROM 82 in advance to the voltage value calculated as described above, and sets the voltage applied to the power supply roller 68 as the secondary transfer voltage such that a desired transfer current flows.

The controller 80 performs image formation by applying the secondary transfer voltage calculated by the ATVC from the power supply roller 68 to the secondary transfer portion T2 (step S3). In a sheet interval after the image formation, the controller 80 applies a sheet interval voltage from the power supply roller 68 to the secondary transfer portion T2 (step S4). In addition, the controller 80 determines whether or not the image formation job has been finished (step S5). In the case where the controller 80 has determined that the image formation job has been not finished, the controller 80 applies the secondary transfer voltage from the power supply roller 68 to the secondary transfer portion T2 to perform image formation again (step S3). In the case where the controller 80 has determined that the image formation job has been finished, the secondary transfer voltage control is finished.

Next, the cleaning control of the secondary transfer portion T2 in the image forming apparatus 1 of the present embodiment will be described. In the present embodiment, the cleaning control of applying a cleaning bias to the power supply roller 68 can be executed at a timing of not transferring a toner image onto the sheet S in the secondary transfer portion T2. The timing of executing such cleaning control is after executing a jam treatment or after executing a control mode such as adjustment of toner density or position deviation of toner images. The jam treatment is a process of, for example, removing a sheet S in the case where a jam in which the sheet S clogs some part of the conveyance path of the image forming apparatus 1 during the image forming operation. In this case, there is a possibility that a jam occurs in a state in which a toner image is on the intermediate transfer belt 56, and there is a case where a large amount of toner on the intermediate transfer belt 56 attaches to the secondary transfer outer roller 64 after the jam treatment.

In addition, in the present embodiment, in a control mode, a patch image as the toner image for control is formed in each of the image forming portions 10a to 10d, carried by the intermediate transfer belt 56, and detected by the density detection sensor 86. Then, density adjustment of the toner images and correction of displacement of toner images of the respective image forming portions 10a to 10d are performed on the basis of the results of the detection by the density detection sensor 86. Since the patch image is not transferred onto the sheet S in the secondary transfer portion T2, there is a case where a large amount of toner on the intermediate transfer belt 56 attaches to the secondary transfer outer roller 64 after executing such a control mode.

In either case, when a large amount of toner passes through the secondary transfer portion T2 without the presence of the sheet S, the large amount of toner attaches to the secondary transfer outer roller 64. This is because toner passes through the secondary transfer portion T2 without the presence of the sheet S and therefore toner attachment to the secondary transfer outer roller 64 is likely to occur. In the case where the next image formation is executed with the toner still attached to the secondary transfer outer roller 64, there is a possibility that back staining of the toner attaching to the back surface of the sheet S passing through the secondary transfer portion T2 occurs. Therefore, in the case where there is a possibility that a large amount of toner is attached to the secondary transfer outer roller 64, cleaning control of the secondary transfer portion T2 to clean the toner attached to the secondary transfer outer roller 64 is performed.

The outline of the cleaning control for the secondary transfer portion T2 will be described with reference to FIGS. 4A to 4D. There are some patterns of cases where the secondary transfer portion T2 causes toner waste t, and the amount of toner contamination of the secondary transfer portion T2 is different therebetween. For example, in the post-rotation after normal image formation, the amount of toner contamination of the secondary transfer portion T2 is about a degree that fogging toner on the intermediate transfer belt 56 attaches to the secondary transfer outer roller 64 and the power supply roller 68 after the sheet S has passed through, which is small. Therefore, an opposite polarity bias having the same polarity as the toner, that is, an opposite polarity to the secondary transfer bias is applied to the power supply nip portion N between the secondary transfer outer roller 64 and the power supply roller 68 for the time t1 corresponding to just one rotation of the secondary transfer outer roller 64. As a result of this, all the toner attached to the secondary transfer outer roller 64 can be discharged onto the intermediate transfer belt 56, and thus the secondary transfer outer roller 64 can be sufficiently cleaned.

Meanwhile, there is a case where a large amount of toner passes through the secondary transfer portion T2 without the presence of the sheet S immediately after executing a control mode of detecting the patch density or the like on the intermediate transfer belt 56 by the density detection sensor 86 and performing density correction or after occurrence of a paper jam. In this case, there is a possibility that a large amount of toner attachment occurs in the secondary transfer portion T2. This is because toner passes through the secondary transfer portion T2 without the presence of the sheet S, and therefore toner attachment to the secondary transfer outer roller 64 is likely to occur. A case where a large amount of toner attachment has occurred in the secondary transfer portion T2 as described above will be described with reference to FIGS. 4A to 4D.

As illustrated in FIG. 4A, in the case where the toner contamination t of a high level has occurred on the secondary transfer outer roller 64 and the power supply roller 68, the controller 80 applies an opposite polarity bias having the same polarity as the toner, that is, an opposite polarity to the secondary transfer bias to the power supply roller 68 as the cleaning bias. When cleaning of the secondary transfer outer roller 64 is started in this manner, negatively charged toner attached to the secondary transfer outer roller 64 is transferred onto the intermediate transfer belt 56.

Then, as illustrated in FIG. 4B, a half of the circumference of the secondary transfer outer roller 64 has been cleaned and the toner waste t still remains on a half of the circumference after the secondary transfer outer roller 64 has rotated by a half rotation. However, the toner waste t still remains on the entire circumference of the power supply roller 68. This is because, during the operation of the secondary transfer outer roller 64 rotating by a half rotation, the toner waste t is present all the time on both of the secondary transfer outer roller 64 and the power supply roller 68 in the power supply nip portion N between the secondary transfer outer roller 64 and the power supply roller 68, and thus the power supply roller 68 is not cleaned. That is, when a large amount of toner is present in the power supply nip portion N, the cleaning bias from the power supply roller 68 becomes insufficient, and therefore the toner waste t on the power supply roller 68 is sometimes not sufficiently cleaned. In addition, there is also a possibility that the toner on the secondary transfer outer roller 64 attaches to the power supply roller 68 by a non-electrostatic attachment force due to contact and friction between the secondary transfer outer roller 64 and the power supply roller 68. Therefore, cleaning of the power supply roller 68 is practically started after the secondary transfer outer roller 64 has rotated by a half rotation as illustrated in FIG. 4B.

After the half rotation of the secondary transfer outer roller 64, an already cleaned part of the secondary transfer outer roller 64 reaches the power supply nip portion N. Therefore, the toner waste t remaining on the power supply roller 68 is transferred onto the secondary transfer outer roller 64, and thus the power supply roller 68 is cleaned. That is, as illustrated in FIG. 4C, when cleaning has been performed by an amount corresponding to one rotation of the secondary transfer outer roller 64, the toner waste t corresponding to one rotation of the power supply roller 68 remains on the secondary transfer outer roller 64.

As illustrated in FIG. 4D, by further performing cleaning for the time t2 corresponding to one rotation of the power supply roller 68 after the secondary transfer outer roller 64 has rotated once, the cleaning of both of the secondary transfer outer roller 64 and the power supply roller 68 can be finished. As described above, in the case of an external power supply configuration of the image forming apparatus 1 of the present embodiment, the time t2 corresponding to one rotation of the power supply roller 68 is required to clean the secondary transfer outer roller 64 and the power supply roller 68 in addition to the time t1 corresponding to one rotation of the secondary transfer outer roller 64.

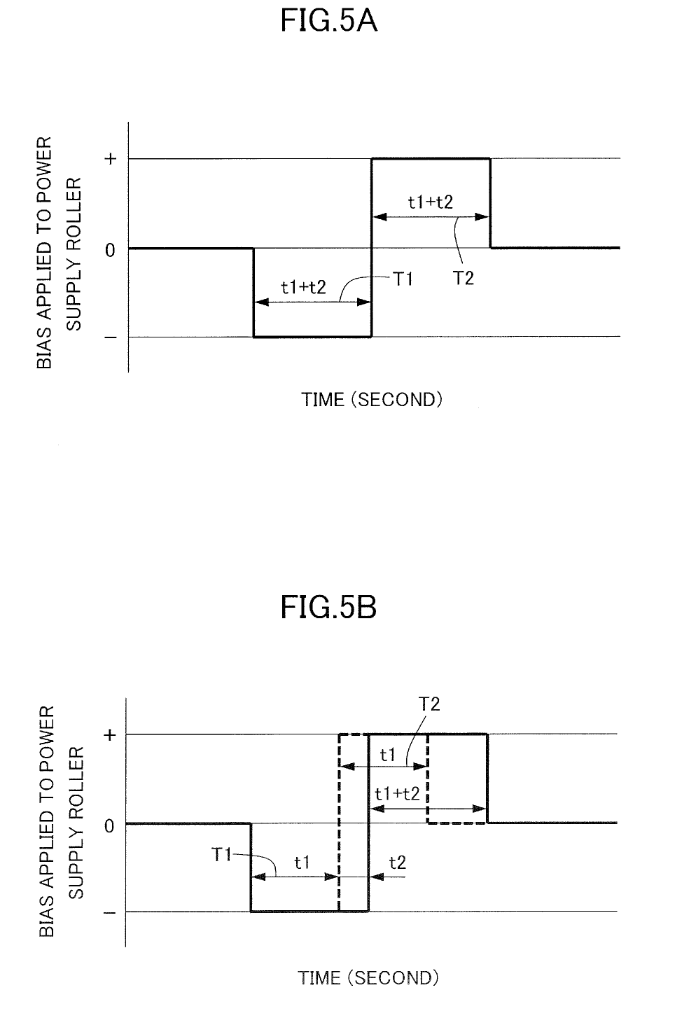

Next, the cleaning bias applied to the power supply roller 68 in the cleaning control of the secondary transfer portion T2 will be described with reference to FIG. 5A. Staining on the secondary transfer outer roller 64 and the power supply roller 68 is cleaned by the cleaning bias applied in the cleaning control. In the toner attached to the secondary transfer outer roller 64, electrically positively charged toner and negatively charged toner are mixed, and the toner is moved back onto the intermediate transfer belt 56 by using this electrical characteristic. The positively charged toner can be cleaned by applying, as the cleaning bias, a same polarity bias having the same polarity as the secondary transfer bias in the direction from the power supply roller 68 to the secondary transfer inner roller 62. The negatively charged toner can be cleaned by applying, as the cleaning bias, an opposite polarity bias having an opposite polarity to the secondary transfer bias in the direction from the secondary transfer inner roller 62 to the power supply roller 68.

By setting the secondary transfer outer roller 64 as an electrical float, biases can be applied in both directions between the power supply roller 68 and the secondary transfer inner roller 62 with the secondary transfer outer roller 64 therebetween. Therefore, the secondary transfer outer roller 64 and the power supply roller 68 can be cleaned by the one high-voltage power source 70.

In the case of cleaning the secondary transfer outer roller 64 and the power supply roller 68, the application time t3 of the bias voltage is set as follows. In this cleaning, it is preferable that the time t2 for reaching the secondary transfer portion T2 by the rotation of the secondary transfer outer roller 64 is provided after the staining on the power supply roller 68 is moved onto the secondary transfer outer roller 64 in addition to the time t1 corresponding to one rotation of the secondary transfer outer roller 64. As illustrated in FIG. 5A, after the cleaning control is started, the controller 80 applies an opposite polarity bias of a negative polarity as a cleaning bias for the time t2 corresponding to one rotation of the power supply roller 68 in addition to the time t1 corresponding to one rotation of the secondary transfer outer roller 64 (t3=t1+t2). As a result of this, the negatively charged toner attached to the secondary transfer outer roller 64 and the power supply roller 68 can be removed. Next, the same polarity bias of the positive polarity is applied as the cleaning bias for the same time t3=t1+t2. As a result of this, the positively charged toner attached to the secondary transfer outer roller 64 and the power supply roller 68 can be removed. As described above, in the case where an external power supply configuration is employed, it is preferable that the bias voltage is applied for a time longer than the time t1 corresponding to one rotation of the secondary transfer outer roller 64 by the time t2 corresponding to one rotation of the power supply roller 68 when respectively applying positive and negative bias voltages.

However, in the case where the cleaning bias is every time applied for t1+t2, there is a possibility that, for example, the cleaning process becomes excessive and the production efficiency of the image formation decreases in the case where the amount of toner contamination of the secondary transfer outer roller 64 and the power supply roller 68 is small. In contrast, in the present embodiment, by switching the processing time in the cleaning control in accordance with the amount of attached toner in the secondary transfer portion T2 in the external power supply configuration, nicely cleaning the power supply roller 68 and the secondary transfer outer roller 64 is enabled while reducing the processing time (see FIG. 5B).

Here, a processing procedure of the cleaning control of the secondary transfer outer roller 64 and the power supply roller 68 in the present embodiment will be described in accordance with a flowchart shown in FIG. 6. When the power of the image forming apparatus 1 is on, the controller 80 determines whether or not it is a timing to execute the cleaning control (cleaning mode) (step S10). Here, the timing to execute the cleaning control is, for example, when the power of the image forming apparatus 1 is turned on, when a user executes an image formation job, when recovering from a paper jam, when discharge control of degraded toner is executed, or the like. That is, the timing is when the image forming apparatus 1 is recovered from a state in which operation is stopped, a case where a large amount of toner is supplied to the secondary transfer portion without the presence of the sheet S, or the like. However, as a matter of course, the timing is not limited to these timings.

In the case where the controller 80 has determined that it is not the timing to execute the cleaning control, the process is finished. In the case where the controller 80 has determined that it is the timing to execute the cleaning control, the controller 80 detects an operation history of the image forming apparatus 1, and estimates the amount of toner contamination of the secondary transfer outer roller 64 or the power supply roller 68 (step S11). At this time, the CPU 81 loads the operation history of the image forming apparatus 1 stored in the ROM 82 or the RAM 83 to estimate the amount of toner contamination. The operation history is information related to the amount of toner contamination of the secondary transfer outer roller 64 or the power supply roller 68. For example, the operation history is information about application time of the cleaning bias in the previous cleaning control, the image ratio or the number of printed sheets in an image formation process thereafter, whether or not a paper jam has occurred, whether or not toner discharge has been performed, whether or not a patch image has been formed, the image ratio of an image carried by the intermediate transfer belt 56 at the time of occurrence of a jam, or the like. Therefore, a dedicated member for estimating the amount of toner contamination does not need to be provided, and thus the increase in the number of parts can be suppressed.

Here, the amount of toner contamination of the secondary transfer outer roller 64 or the power supply roller 68 is estimated to be small during, for example, a post-rotation after normal image formation. In contrast, in the case where, for example, a jam of the sheet S has occurred before the secondary transfer portion T2, a large amount of toner passes through the secondary transfer portion T2 without the presence of the sheet S, and therefore a large amount of toner attaches to the secondary transfer outer roller 64 and the power supply roller 68. Therefore, the amount of toner contamination of the secondary transfer outer roller 64 or the power supply roller 68 is estimated to be large. In addition, in the present embodiment, in the case where it has been determined that the state of the toner accommodated in the developing apparatuses 53a to 53d has deteriorated due to use or environmental change, the controller 80 causes the toner of the developing apparatuses 53a to 53d to be discharged onto the intermediate transfer belt 56, and collects the toner by the belt cleaning apparatus 65. Also in this case, a large amount of toner passes through the secondary transfer portion T2 without the presence of the sheet S, and therefore a large amount of toner attaches to the secondary transfer outer roller 64 and the power supply roller 68. Therefore, the amount of toner contamination of the secondary transfer outer roller 64 or the power supply roller 68 is estimated to be large.

The controller 80 determines whether or not the estimated amount of toner contamination is equal to or larger than a predetermined amount (step S12). In the case where the controller 80 has determined that the estimated amount of toner contamination is not equal to or larger than the predetermined amount, the cleaning control is executed as in the normal operation because the amount of toner contamination is small. In this case, the amount of toner attaching to the secondary transfer outer roller 64 and the power supply roller 68 is small, and therefore the second cleaning mode in which the application time t3 of the cleaning bias is t1 is executed (step S13). That is, the controller 80 first applies, as the cleaning bias, the opposite polarity bias of the negative polarity for just the time t1 corresponding to one rotation of the secondary transfer outer roller 64 to clean the negatively charged toner (see a broken line of FIG. 5B). Next, the controller 80 applies, as the cleaning bias, the same polarity bias of the positive polarity for just the time t1 corresponding to one rotation of the secondary transfer outer roller 64 to clean the positively charged toner (see a broke line of FIG. 5B). As a result of this, the toner on the secondary transfer outer roller 64 and the power supply roller 68 can be discharged onto the intermediate transfer belt 56, and the execution of the cleaning control is finished. As described above, in the case where the amount of toner contamination is small, the processing time can be reduced by setting the time t1 corresponding to one rotation of the secondary transfer outer roller 64 as the application time t3 of the cleaning bias for each of the positive and negative cases.

In contrast, in the case where the controller 80 has determined that the estimated amount of toner contamination is equal to or larger than the predetermined amount, the cleaning control is performed as in the predetermined operation because the amount of toner contamination is large. In this case, since the amount of toner attaching to the secondary transfer outer roller 64 and the power supply roller 68 is large, the first cleaning mode in which the application time t3 of the cleaning bias is t1+t2 is executed (step S14). In this case, it is difficult to discharge toner from the power supply roller 68 in only the time t1 in which the secondary transfer outer roller 64 rotates once because a large amount of toner is present on the secondary transfer outer roller 64. Therefore, the opposite polarity bias of the negative polarity is first applied as the cleaning bias for the time t1 corresponding to one rotation of the secondary transfer outer roller 64 to clean the negatively charged toner and then further for the time t2 corresponding to one rotation of the power supply roller 68. That is, the opposite polarity bias is applied at least for a period of t1+t2. As a result of this, since the opposite polarity bias is applied for the time of t3 =t1+t2 in total, the toner that has moved from the power supply roller 68 onto the secondary transfer outer roller 64 can be also nicely cleaned (see a solid line of FIG. 5B).

Next, the controller 80 applies, as the cleaning bias, the same polarity bias of the positive polarity for the time t1 corresponding to one rotation of the secondary transfer outer roller 64 and then further for the time t2 corresponding to one rotation of the power supply roller 68 to clean the positively charged toner. That is, the same polarity bias is applied for at least a period of t1+t2. As a result of this, the same polarity bias is applied for the time of t3=t1+t2 in total, the toner that has moved from the power supply roller 68 onto the secondary transfer outer roller 64 can be also nicely cleaned (see a solid line of FIG. 5B). As a result of this, the toner on the secondary transfer outer roller 64 and the power supply roller 68 can be discharged onto the intermediate transfer belt 56, and thus the execution of the cleaning control is finished. As described above, in the case where the amount of toner contamination is large, sufficient cleaning of the secondary transfer outer roller 64 and the power supply roller 68 can be realized by setting t1+t2 as the application time t3 of the cleaning bias for each of the positive and negative cases.

That is, in the present embodiment, for example, in the case where a jam of the sheet S has occurred (step S10; YES) and the image ratio of the image that has been formed immediately before is smaller than a predetermined ratio (step S12; NO), the controller 80 executes the second cleaning mode (step S13). In addition, for example, in the case where a jam of the sheet S has occurred (step S10; YES) and the image ratio of the image that has been formed immediately before is equal to or larger than the predetermined ratio (step S12; YES), the controller 80 executes the first cleaning mode (step S14). To be noted, although a case where, for example, the first cleaning mode and the second cleaning mode are executed by switching therebetween in accordance with the image ratio in the case where a jam has occurred has been described in the present embodiment, this is not limiting. For example, the first cleaning mode may be always executed regardless of the image ratio in the case where a jam has occurred.

As described above, according to the image forming apparatus 1 of the present embodiment, the controller 80 is provided with, as the cleaning control, the first cleaning mode including a period equal to or longer than (t1+t2) of continuously applying the opposite polarity bias to the power supply roller 68. Therefore, the toner attached to the secondary transfer outer roller 64 and the power supply roller 68 can be electrostatically moved onto the intermediate transfer belt 56 and thus cleaned. As a result of this, reattachment of toner to the sheet S can be suppressed without additionally providing a cleaning member to the power supply roller 68 in the image forming apparatus 1 including the power supply roller 68.

In addition, according to the image forming apparatus 1 of the present embodiment, the controller 80 is capable of switching and executing, as the cleaning control, the second cleaning mode satisfying the relationship of t3=1 and the first cleaning mode satisfying the relationship of t3=t1+t2. Therefore, in the second cleaning mode, decrease in the productivity can be avoided without elongating the application time t3 of the cleaning bias more than needed. In addition, in the first cleaning mode, the secondary transfer outer roller 64 and the power supply roller 68 to which toner is attached can be nicely cleaned without shortening the application time t3 of the cleaning bias more than needed. As a result of this, decrease in the productivity can be avoided while maintaining good electrostatic cleaning characteristics of the secondary transfer outer roller 64 and the power supply roller 68 to which toner is attached.

In addition, according to the image forming apparatus 1 of the present embodiment, the controller 80 is, in the cleaning control, capable of rotating the intermediate transfer belt 56, the secondary transfer outer roller 64, and the power supply roller 68 while applying the opposite polarity bias having the opposite polarity to the transfer bias from the high-voltage power source 70. Then, the controller 80 is capable of cleaning the secondary transfer outer roller 64 and the power supply roller 68 by rotating the intermediate transfer belt 56, the secondary transfer outer roller 64, and the power supply roller 68 while applying the same polarity bias having the same polarity as the transfer bias from the high-voltage power source 70. As a result of this, the negatively charged toner can be cleaned by applying the opposite polarity bias, and then the positively charged toner can be cleaned by applying the same polarity bias. Therefore, both the negatively charged and positively charged toners can be cleaned by the series of operations, and thus efficient cleaning can be realized.

In addition, according to the image forming apparatus 1 of the present embodiment, the controller 80 executes the second cleaning mode as in the normal operation in the case where it has been determined that the estimated amount of toner contamination is smaller than the predetermined amount. The controller 80 executes the first cleaning mode as in the predetermined operation in the case where it has been determined that the estimated amount of toner contamination is equal to or larger than the predetermined amount. Therefore, since the cleaning mode is switched in accordance with whether the amount of toner contamination is large or small, decrease in the productivity can be avoided while maintaining good electrostatic cleaning characteristics of the secondary transfer outer roller 64 and the power supply roller 68 to which toner is attached.

In addition, according to the image forming apparatus 1 of the present embodiment, the controller 80 applies the opposite polarity bias such that the application time t3 of the cleaning bias is t1 in the second cleaning mode. Therefore, since the application time t3 of the cleaning bias is set to be the same as the time t1 corresponding to one rotation of the secondary transfer outer roller 64, decrease in the productivity can be avoided while cleaning the entire circumference of the secondary transfer outer roller 64 without elongating the application time t3 of the cleaning bias more than needed. In addition, the controller 80 applies the opposite polarity bias such that the application time t3 of the cleaning bias is t1+t2 in the first cleaning mode. Therefore, the application time t3 of the cleaning bias is set to be the same as the sum of the time t1 corresponding to one rotation of the secondary transfer outer roller 64 and the time t2 corresponding to one rotation of the power supply roller 68. As a result of this, the secondary transfer outer roller 64 and the power supply roller 68 can be nicely cleaned without shortening the application time t3 of the cleaning bias more than needed.

In addition, according to the image forming apparatus 1 of the present embodiment, since the controller 80 estimates the amount of toner contamination on the basis of the operation history of the image forming apparatus 1, a dedicated member for estimating the amount of toner contamination is not needed, and thus increase in the number of parts can be suppressed.

In addition, in the image forming apparatus 1 of the present embodiment, in the case where a jam of the sheet S has occurred, the controller 80 executes the second cleaning mode when the image ratio of the image that has been formed immediately before is smaller than the predetermined ratio, and executes the first cleaning mode when the image ratio is equal to or larger than the predetermined ratio. Therefore, decrease in the productivity can be avoided while maintaining good electrostatic cleaning characteristics of the secondary transfer outer roller 64 and the power supply roller 68 to which toner is attached also at the time of occurrence of a jam of the sheet S.

To be noted, although a case where the opposite polarity bias is applied such that the application time t3 of the cleaning bias is t1 in the second cleaning mode has been described for the image forming apparatus 1 of the first embodiment described above, this is not limiting. For example, in the second cleaning mode, it suffices as long as the application time t3 of the cleaning bias satisfies a relationship of t1≤t3<t1+t2. Also in this case, decrease in the productivity can be avoided without elongating the application time t3 of the cleaning bias more than needed.

In addition, although a case where the opposite polarity bias is applied such that the application time t3 of the cleaning bias is t1+t2 in the first cleaning mode has been described for the image forming apparatus 1 of the first embodiment, this is not limiting. For example, in the first cleaning mode, it suffices as long as the application time t3 of the cleaning bias satisfies a relationship of t3≥t1+t2. Also in this case, the secondary transfer outer roller 64 and the power supply roller 68 to which toner is attached can be nicely cleaned without shortening the application time t3 of the cleaning bias more than needed. To be noted, although it suffices as long as the relationship of t3≥t1+t2 is satisfied in the first cleaning mode, the period of applying the cleaning bias preferably satisfies (t1+t2)×10≥t3≥t1+t2 to avoid decrease in the productivity. Further, the period of applying the cleaning bias more preferably satisfies (t1+t2)×5≥t3≥t1+t2. As a result of this, decrease in the productivity can be avoided while maintaining good electrostatic cleaning characteristics of the secondary transfer outer roller 64 and the power supply roller 68.

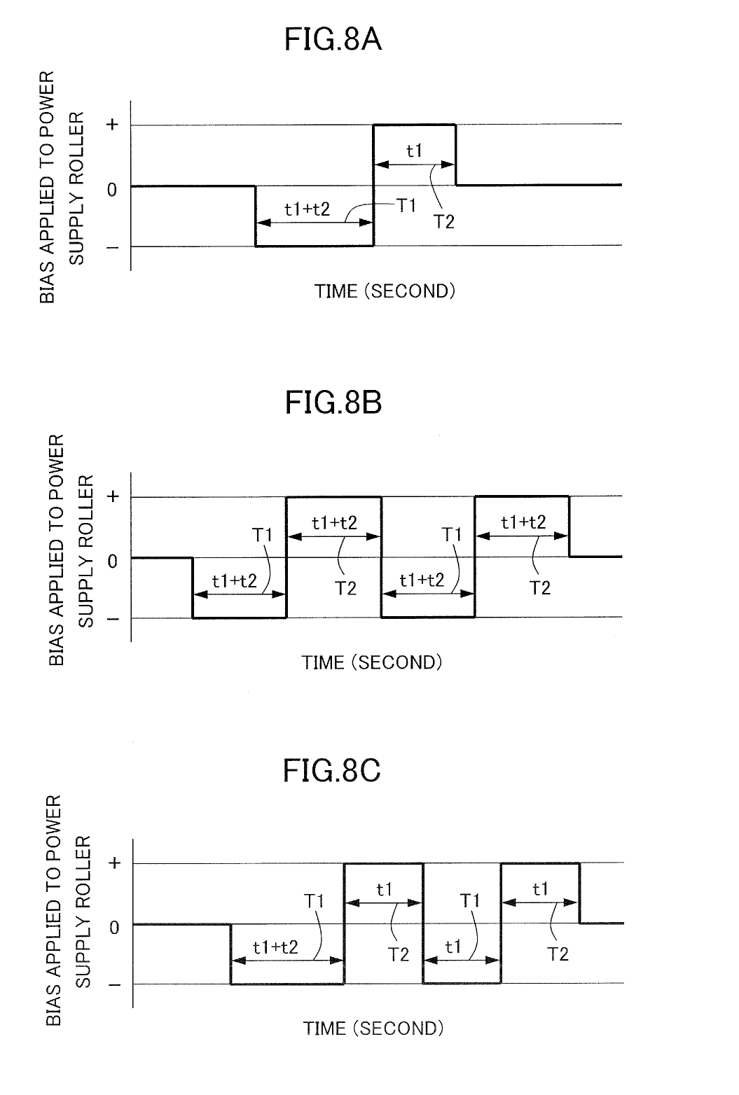

In addition, although a case where the same polarity bias is applied for the same time t3 =t1+t2 as the application time of the opposite bias after applying the opposite polarity bias has been described for the image forming apparatus 1 of the first embodiment, this is not limiting. The application time of the same polarity bias may be different from the application time of the opposite polarity bias. For example, in the case where the application time of the opposite polarity bias is t1, the application time of the same polarity bias may be t1+t2. Alternatively, for example, in the case where the application time of the opposite polarity bias is set to t1+t2 in the first cleaning mode as illustrated in FIG. 8A, the application time of the same polarity bias may be set to t1. This is because, since most of the toner that attaches to the secondary transfer outer roller 64 and the power supply roller 68 is considered to be toner having a negative polarity, most of the toner can be cleaned by the first application of the opposite polarity bias. Therefore, as illustrated in FIG. 8A, the application time of the same polarity bias may be configured as a time in which the secondary transfer outer roller 64 rotates at least once. In other words, in the case where the maximum time in which the same polarity bias is continuously applied in the first cleaning mode is t4, a relationship of t1≤t4<t1+t2 may be satisfied.

In addition, although a case where the opposite polarity bias and the same polarity bias are each sequentially applied once in each cleaning mode has been described for the image forming apparatus 1 of the first embodiment, this is not limiting. For example, as illustrated in FIG. 8B, a configuration in which the opposite polarity bias and the same polarity bias are further sequentially applied continuously after applying the opposite polarity bias and the same polarity bias may be employed. In this case, in the first cleaning mode, for example, the first application time of the opposite polarity bias may be t1+t2, the first application time of the same polarity bias may be t1+t2, the second application time of the opposite polarity bias may be t1, and the second application time of the same polarity bias may be t1. Alternatively, in the first cleaning mode, for example, the first application time of the opposite polarity bias may be t1+t2, and the first application time of the same polarity bias, the second application time of the opposite polarity bias, and the second application time of the same polarity bias may be each t1 as illustrated in FIG. 8C. The reason why the application time of the same polarity bias can be shortened as illustrated in FIGS. 8B and 8C is because most of the toner attaching to the secondary transfer outer roller 64 and the power supply roller 68 can be cleaned by the first application of the opposite polarity bias.

In addition, although the image forming apparatus 1 of the first embodiment is configured such that the opposite polarity bias and the same polarity bias are both applied as the cleaning control, this is not limiting. For example, only the opposite polarity bias may be applied without applying the same polarity bias. This is because the content of the positively charged toner in the developer is small as compared with the negatively charged toner. However, it is preferable that both of the opposite polarity bias and the same polarity bias are applied to realize good cleaning.

In addition, although a case where the rotation time in which the secondary transfer outer roller 64 rotates one round is t1, the rotation time in which the power supply roller 68 rotates one round is t2, and t1>t2 is satisfied has been described for the image forming apparatus 1 of the first embodiment, t1<t2 may be satisfied. In this case, the time of applying the bias of each polarity (see step S13) in the second cleaning mode may be not t1 but t2. That is, in the case where t1<t2 is satisfied, by setting the time of applying the bias of each polarity in the second cleaning mode to t2, the secondary transfer outer roller 64 and the power supply roller 68 can be each made to rotate once while the bias of each polarity is continuously applied.

In addition, although a case where the application times of the opposite polarity bias and the same polarity bias in the first cleaning mode are each set to t1+t2 has been described for the image forming apparatus 1 of the first embodiment, this is not limiting. For example, the application time may be shorter than t1+t2 even in the first cleaning mode in the case where the toner attached to the power supply roller 68 due to the application of the opposite polarity bias can be immediately discharged onto the secondary transfer outer roller 64. In this case, for example, the position of an intersection point of a line connecting the centers of the secondary transfer outer roller 64 and the power supply roller 68 and the secondary transfer outer roller 64 at the start of application of the cleaning bias is set as a point P (see FIG. 4A). That is, the point P is a point at which the secondary transfer outer roller 64 is in contact with the power supply roller 68 at the start of the cleaning. When the secondary transfer outer roller 64 rotates by a half rotation, the point P reaches the intermediate transfer belt 56, that is, the secondary transfer portion T2 (see FIG. 4B). In the case where the time in which the secondary transfer outer roller 64 rotates by a half rotation is t0 (=t1/2), the time required for the toner attached to the power supply roller 68 corresponding to one rotation to be conveyed to the intermediate transfer belt 56 via the secondary transfer outer roller 64 is (t2+t0). Meanwhile, the time required for the toner attached to the secondary transfer outer roller 64 corresponding to one rotation to be conveyed to the intermediate transfer belt 56 is t1. To be noted, in the present embodiment, since the power supply nip portion N and the secondary transfer portion T2 are disposed so as to be displaced by approximately 180° in the rotation direction of the secondary transfer outer roller 64, t0=t1/2 holds. To be noted, the arrangement of the power supply nip portion N and the secondary transfer portion T2 is not limited to the 180° displacement, and t0=t1/2 does not hold in the case where the angle of displacement is not 180°.

Therefore, it suffices to convey the toner attached to both of the power supply roller 68 and the secondary transfer outer roller 64 to the intermediate transfer belt 56 that the continuous application time of the opposite polarity bias and the same polarity bias is equal to or longer than the longer one of t1 and (t2+t0). That is, in the case where t1≥(t2+t0) holds, it is preferable that the cleaning control includes a period in which the opposite polarity bias and the same polarity bias are each at least continuously applied for a time equal to or longer than t1. In addition, in the case where t1<(t2+t0) holds, it is preferable that the cleaning control includes a period in which the opposite polarity bias and the same polarity bias are each at least continuously applied for a time equal to or longer than (t2+t0). As a result of this, decrease in the productivity can be avoided while maintaining good electrostatic cleaning characteristics of the secondary transfer outer roller 64 and the power supply roller 68. In addition, in the second cleaning mode, the continuous application time of the opposite polarity bias and the same polarity bias may be equal to or longer than the longer one of t1 and (t2+t0).

In addition, in the case of setting the continuous application time of the cleaning bias to be equal to or longer than the longer one of t1 and (t2+t0), it is preferable to provide an upper limit value to the continuous application time in consideration of the productivity. For example, in the case where the time of the longer one of t1 and (t2+t0) is tL, the continuous application time of the cleaning bias is preferably equal to or shorter than tL×10 at longest, and more preferably equal to or shorter than tL×5. As a result of this, decrease in the productivity can be avoided while maintaining good electrostatic cleaning characteristics of the secondary transfer outer roller 64 and the power supply roller 68.

### Second Embodiment

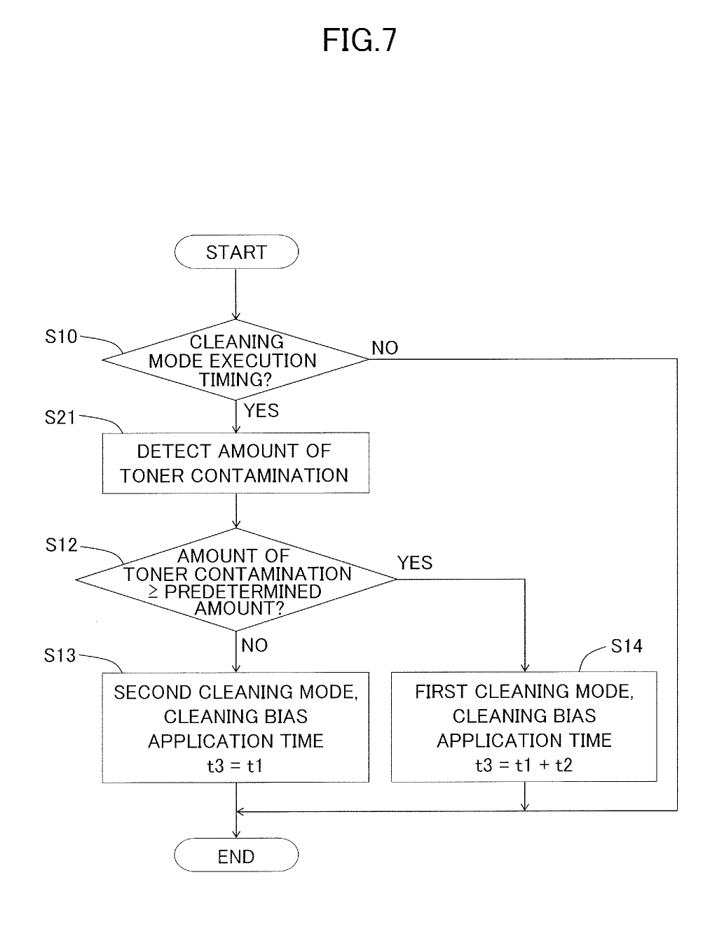

Next, a second embodiment of the present invention will be described in detail with reference to FIG. 7. The configuration of the present embodiment is different from that of the first embodiment in that the amount of toner contamination of the power supply roller 68 is detected by the optical sensor 87 (see FIG. 1). However, the other elements thereof are the same as in the first embodiment, and therefore the same reference signs will be used and detailed descriptions thereof will be omitted.

In the present embodiment, as illustrated in FIG. 1, the optical sensor (detection means) 87 is provided to oppose the surface of the power supply roller 68. The optical sensor 87 is connected to the controller 80 (see FIG. 2), and is capable of detecting the reflectance of the surface of the power supply roller 68 as a value related to toner contamination of the power supply roller 68. The optical sensor 87 is a sensor that detects, by a light receiving portion, a specular reflection component of reflection light of light radiated from a light emitting portion toward the surface of the power supply roller 68. The optical sensor 87 determines the amount of attached toner by using the fact that the amount of specular reflection light is smaller in the case where the amount of attached toner on the power supply roller 68 is larger, and the amount of specular reflection light is larger in the case where the amount of attached toner is smaller. The controller 80 executes the second cleaning mode in the case where the reflectance detected by the optical sensor 87 is smaller than a predetermined value, and executes the first cleaning mode in the case where the reflectance is equal to or larger than the predetermined value.

As illustrated in FIG. 7, the processing procedure of the cleaning control of the secondary transfer outer roller 64 and the power supply roller 68 of the present embodiment is different in that step S21 is provided instead of step S11 of the flowchart shown in FIG. 6, but the other processes are the same. As illustrated in FIG. 7, when the power of the image forming apparatus 1 is on, the controller 80 determines whether or not it is a timing to execute the cleaning control (step S10).

In the case where the controller 80 has determined that it is the timing to execute the cleaning control, the controller 80 detects the reflectance of the power supply roller 68 from the optical sensor 87, and detects the amount of toner contamination of the power supply roller 68 on the basis of this (step S21). As a determination method for the amount of toner contamination, the amount of reflection light of the power supply roller 68 in a brand-new state that is stored in the ROM 82 in advance is used as the amount of reflection light in the case where no toner attachment has occurred, and, for example, it is determined that the amount of attached toner is large in the case where the detected amount of reflection light is equal to or smaller than a half of that of the brand-new state. Next, similarly to the first embodiment, whether or not the amount of toner contamination is equal to or larger than a predetermined amount is determined (step S12). The controller 80 executes the second cleaning mode in the case where the amount of toner contamination is not equal to or larger than the predetermined value (step S13), and executes the first cleaning mode in the case where the amount of toner contamination is equal to or larger than the predetermined value (step S14).

Also according to the image forming apparatus 1 of the present embodiment, the controller 80 is provided with, as the cleaning control, the first cleaning mode including a period equal to or longer than (t1+t2) of continuously applying the opposite polarity bias to the power supply roller 68. Therefore, the toner attached to the secondary transfer outer roller 64 and the power supply roller 68 can be electrostatically moved onto the intermediate transfer belt 56 and thus cleaned. As a result of this, reattachment of toner to the sheet S can be suppressed without additionally providing a cleaning member to the power supply roller 68 in the image forming apparatus 1 including the power supply roller 68.

In addition, according to the image forming apparatus 1 of the present embodiment, in the second cleaning mode, decrease in the productivity can be avoided without elongating the application time t3 of the cleaning bias is not elongated more than needed. In addition, in the first cleaning mode, the secondary transfer outer roller 64 and the power supply roller 68 to which toner is attached can be nicely cleaned without shortening the application time t3 of the cleaning bias more than needed. As a result of this, decrease in the productivity can be avoided while maintaining good electrostatic cleaning characteristics of the secondary transfer outer roller 64 and the power supply roller 68 to which toner is attached. Further, according to the image forming apparatus 1 of the present embodiment, since the optical sensor 87 is applied as the detection means configured to detect a value related to toner contamination of the power supply roller 68, the amount of toner contamination can be directly detected, and thus switching of the cleaning mode can be executed highly precisely.

To be noted, although a case where the optical sensor 87 is capable of detecting the reflectance of the surface of the power supply roller 68 has been described for the image forming apparatus 1 of the second embodiment described above, this is not limiting, and for example, the optical sensor 87 may be capable of detecting the reflectance of the surface of the secondary transfer outer roller 64. That is, it suffices as long as the optical sensor 87 is capable of detecting the reflectance of at least one of the secondary transfer outer roller 64 and the power supply roller 68. In either case, the amount of toner contamination can be directly detected, and switching of the cleaning mode can be executed highly precisely.

In addition, although a case where the optical sensor 87 is applied as the detection means configured to detect a value related to toner contamination of at least one of the secondary transfer outer roller 64 and the power supply roller 68 has been described for the image forming apparatus 1 of the second embodiment described above, this is not limiting. The detection means may be, for example, a current detection means configured to detect a transfer current of the secondary transfer portion T2. In this case, the controller 80 is capable of detecting the amount of toner contamination of the secondary transfer outer roller 64 by using, as a detected value, a value related to a relationship between a current detected by the current detection means when a test bias is applied to the power supply roller 68 in a non-image formation time and the applied test bias. According to this, the controller 80 does not need to be provided with a dedicated member to detect the amount of toner contamination, and thus increase in the number of parts can be suppressed.

In addition, in the image forming apparatus 1 of the second embodiment described above, the detection means may be a current detection means that detects a current while the driving motor 88 of the secondary transfer inner roller 62 is driving. In this case, the controller 80 is capable of detecting the amount of toner contamination of the secondary transfer inner roller 62 by using the current detected by the current detection means while the driving motor 88 is driving as a detected value. Here, in the case where toner contamination is accumulated on the secondary transfer outer roller 64, the rotational drag of the secondary transfer outer roller 64 in the power supply nip portion N increases, thus the driving torque of the intermediate transfer belt 56 increases, and the current while the driving motor 88 is driving changes. Therefore, the controller 80 detects the driving torque of the intermediate transfer belt 56 on the basis of the current while the driving motor 88 of the secondary transfer inner roller 62 is driving, and determines that the amount of toner contamination is large in the case where this driving torque is large. Also in this case, the controller 80 does not need to be provided with a dedicated member to detect the amount of toner contamination, and thus increase in the number of parts can be suppressed.

### EXAMPLES

The toner contamination of the power supply roller 68 was investigated by using the image forming apparatus 1 of the first embodiment described above and setting the process speed to a peripheral speed of 300 mm/sec in a temperature/humidity environment of 30° C. and 80% RH. During operation, the secondary transfer portion T2 was intentionally contaminated with toner by forming a full-gradation solid image and a halftone image and passing the images through the secondary transfer portion T2 without using the sheet S, and the effect of cleaning control performed thereafter was confirmed. The effect confirmation of the cleaning control was performed by passing the sheet S through the image forming apparatus 1 after performing the cleaning control and then confirming toner attachment to the back surface thereof. As a method for forming a black image or a halftone image without causing the sheet S to pass through, for example, the power of the apparatus body was turned off in a period from performing image formation to the sheet S passing through the secondary transfer portion T2, and the power of the apparatus body was then turned on again. As a result of this, toner can be delivered to the secondary transfer portion T2 without causing the sheet S to pass through.

### Example 1

As illustrated in FIG. 5A, the same polarity bias was set to 1 kV, the opposite polarity bias was set to −1 kV, and each bias was applied for a total time t1+t2 of the rotation time t1 in which the secondary transfer outer roller 64 rotated one round and the rotation time t2 in which the power supply roller 68 rotated one round. As a result of this, it was confirmed that the black toner did not attach to the back surface of the sheet S that has been caused to pass through after the cleaning control.

### Example 2

5000 paper sheets of an A4 size (GF-0081 manufactured by Canon (grammage: 81.4 g/m²)) were successively caused to pass through. Here, as indicated by a broken line in FIG. 5B, the same polarity bias was set to 1 kV, the opposite polarity bias was set to −1 kV, and each bias was applied for the rotation time t1 in which the secondary transfer outer roller 64 rotated one round. As a result of this, it was confirmed that the black toner did not attach to the back surface of the sheet S that has been caused to pass through after the cleaning control.

### Comparative Example 1

As indicated by a broken line in FIG. 5B, the same polarity bias was set to 1 kV, the opposite polarity bias was set to −1 kV, and each bias was applied for the rotation time t1 in which the secondary transfer outer roller 64 rotated one round without using a sheet. As a result of this, it was confirmed that the black toner attached to the back surface of the sheet S that has been caused to pass through after the cleaning control.

Therefore, it was confirmed that, by using the image forming apparatus 1 of the present embodiment, decrease in the productivity can be avoided while maintaining good electrostatic cleaning characteristics of the secondary transfer outer roller 64 and the power supply roller 68 to which tone is attached.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

According to the present invention, regarding the image forming apparatus including the power feeding roller, the image forming apparatus capable of suppressing reattachment of toner to a recording material without additionally providing a cleaning member to the power feeding roller is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### INDUSTRIAL APPLICABILITY

The present image forming apparatus can be used for an image forming apparatus such as a copier, a printer, a facsimile machine, or a multifunctional apparatus having a plurality of functions of these, and can be particularly preferably used for one including a power feeding roller.

What is claimed is:

1. An image forming apparatus comprising:
an image bearing member configured to bear a toner image;
a transfer roller comprising a conductive shaft portion and an elastic layer formed around the conductive shaft portion, the transfer roller forming a transfer portion where the transfer roller is in contact with an outer surface of the image bearing member to transfer the toner image borne on the image bearing member onto a recording medium;
a power feeding roller configured to rotate while in contact with the transfer roller to supply a current to the transfer roller to transfer the toner image at the transfer portion;
a power source configured to apply a transfer bias to the power feeding roller; and
a controller configured to execute a cleaning mode of cleaning the power feeding roller by applying a bias from the power source to the power feeding roller to transfer toner adhering on the power feeding roller to the image bearing member through the transfer roller in a non-image formation period in which a toner image for being transferred onto a recording material is not formed,
wherein the controller is configured to execute the cleaning mode in such a manner that, in a case where a rotation time in which the transfer roller rotates one round is t1 and a rotation time in which the power feeding roller rotates one round is t2, the cleaning mode comprises a period equal to or longer than (t1+t2) in which an opposite polarity bias having an opposite polarity to the transfer bias is continuously applied from the power source to the power feeding roller.

2. The image forming apparatus according to claim 1, wherein the controller is configured to execute the cleaning mode in such a manner that the cleaning mode comprises a period equal to or longer than (t1+t2) in which a same polarity bias having the same polarity as the transfer bias is continuously applied from the power source to the power feeding roller while rotating the image bearing member, the transfer roller, and the power feeding roller.

3. The image forming apparatus according to claim 1, wherein, in the cleaning mode, the controller is configured to rotate the image bearing member, the transfer roller, and the power feeding roller while applying the opposite polarity bias having the opposite polarity to the transfer bias from the power source to the power feeding roller, and then rotate the image bearing member, the transfer roller, and the power feeding roller while applying a same polarity bias having the same polarity as the transfer bias from the power source to the power feeding roller.

4. The image forming apparatus according to claim 1,
wherein the cleaning mode is a first cleaning mode,
wherein the controller is configured to execute a second cleaning mode of cleaning the power feeding roller by applying a bias from the power source to the power feeding roller to transfer toner adhering on the power feeding roller to the image bearing member through the transfer roller in a period during which no image is formed, and
wherein a period in which the opposite polarity bias is continuously applied in the second cleaning mode is shorter than (t1+t2) at longest.

5. The image forming apparatus according to claim 1, wherein, in the cleaning mode executed by the controller, in a case where there are a plurality of periods in which the opposite polarity bias is continuously applied, a period in which the opposite polarity bias is applied for the first time is the longest.
